(19) United States
(12) Patent Application Publication
(10) Pub. No.: US 2016/0153234 A1
(43) Pub. Date: Jun. 2, 2016

(54) LADDER SUPPORT

(71) Applicant: JAYDEE GROUP USA INC., Linden, NJ (US)

(72) Inventor: Troy Mazanek, Ronkonkama, NY (US)

(73) Assignee: JAYDEE GROUP USA INC., Linden, NJ (US)

(21) Appl. No.: 14/555,614

(22) Filed: Nov. 27, 2014

(51) Int. Cl. E06C 7/06; F16B 7/10; E06C 1/12

(52) U.S. Cl. CPC E06C 7/06; E06C 1/12; F16B 7/10

(57) ABSTRACT

Apparatus and methods for supporting a ladder are provided. Some embodiments may include a ladder. Such a ladder may include an engagement member for engaging a structure. The ladder may also include a telescoping member. The telescoping member may include an outer member and an inner member. The outer member may preferably be slideably engaged to the inner member. The ladder may further include at least one locking member for fixing the position of the outer member with respect to the position of the inner member. The telescoping member may preferably be hingedly attached to the ladder via a rotatable rung for attaching to the outer member, or hingedly attached to the ladder using any other suitable device. In one configuration, the outer member may be stored substantially parallel to a longitudinal axis of the ladder. In another configuration, the support engagement member may engage the structure.

### FIELD OF THE INVENTION

Present embodiments relate to ladders. Specifically, the present embodiments relate methods and devices for supporting ladders when the ladders are used to gain access to a higher level of elevation.

### BACKGROUND

Building codes typically require that a ladder be secured prior to use. For example, building codes typically require that when scaffolding professionals climb on a ladder to gain access to a first level of the scaffolding, the ladder must be secure.

Extension ladders used by scaffolding professionals may include a rope. The rope is typically included as part of a pulley system that may be used to extend the ladder to a greater height. However, in the field, the rope is often tied to the structure which is being accessed in order to secure the ladder to the structure. The rope, however, may be considered a sub-optimal method for securing the ladder to the structure at least because of the highly flexible nature of the rope. Moreover, the rope may be considered sub-optimal because it requires extensive threading and tying prior to each use.

It would be desirable to provide a ladder support that secures the ladder against displacement prior to use.

It would be further desirable to provide a preferably fixed ladder support that could, in certain embodiments, be attached and detached from the ladder so as to avoid the need for threading and/or tying a rope in order to secure the ladder against displacement.

### SUMMARY

A ladder support is provided. The ladder support may include an engagement member for engaging a structure. The ladder support may further include a rung attachment assembly for engaging at least one rung of a ladder. The ladder support may also include a telescoping member. The telescoping member may include a first tube (or other suitably shaped member) of a first diameter and a second tube (or other suitably-shaped member) of a second diameter. The first diameter may be greater than the second diameter. The second diameter may be greater than the first diameter. The telescoping member preferably couples the engagement member to the rung attachment assembly.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an exemplary ladder support according to certain embodiments;

FIG. 2 shows a carrying member according to certain embodiments;

FIG. 3 shows a telescoping member according to certain embodiments;

FIG. 4 shows a rung attachment assembly member according to certain embodiments;

FIG. 5 shows a rung insertion member according to certain embodiments;

FIG. 6 shows a structure-engaging member according to certain embodiments;

FIG. 7 shows structure-engaging attachment member according to certain embodiments;

FIG. 8 shows a right-angle attachment member according to certain embodiments;

FIG. 9 shows a handle according to certain embodiments;

FIG. 10 shows a removable rung assembly plate according to certain embodiments;

FIG. 11 shows a collar member according to certain embodiments;

FIG. 12 shows fixed rung attachment assembly end plate according to certain embodiments;

FIG. 13 shows a first portion of a rung attachment assembly t-joint according to certain embodiments;

FIG. 14 shows a second portion of the rung attachment assembly t-joint according to certain embodiments;

FIG. 15 shows a rung attachment assembly end bolt according to certain embodiments;

FIG. 16 shows a tube stabilization bolt according to certain embodiments;

FIG. 17 shows a first portion of a rung attachment assembly according to certain embodiments;

FIG. 18 shows a second portion of the rung attachment assembly according to certain embodiments;

FIG. 19 shows an elevational view of the removable rung attachment assembly plate and collar according to certain embodiments;

FIG. 20 shows a top-down view of the removable rung attachment assembly plate and collar taken from line A-A of FIG. 19 according to certain embodiments;

FIG. 21 shows a side view of the removable rung attachment assembly plate and collar according to certain embodiments;

FIG. 22 shows an elevational view of the rung attachment assembly according to certain embodiments;

FIG. 23 shows an elevational view of a portion of the rung attachment assembly according to certain embodiments;

FIG. 24 shows an elevational view rung attachment assembly end bolt according to certain embodiments;

FIG. 25 shows an end view of the rung attachment assembly according to certain embodiments;

FIG. 26 shows an elevational view of a t-portion of the rung attachment assembly according to certain embodiments;

FIG. 27 shows a bottom view of a t-portion of the rung attachment assembly according to certain embodiments;

FIG. 28 shows a cut-away view of a t-portion of the rung attachment assembly according to certain embodiments;

FIG. 29 shows a side view of the carrying member according to certain embodiments;

FIG. 30 shows a top view of the carrying member according to certain embodiments;

FIG. 31 shows an end view of the carrying member according to certain embodiments;

FIG. 32 shows an elevational view of an end portion of carrying member according to certain embodiments;

FIG. 33 shows an elevational view of the carrying member according to certain embodiments;

FIG. 34 shows an elevational view of the structure-engaging member according to certain embodiments;

FIG. 35 shows a top-down view of the structure-engaging member according to certain embodiments;

FIG. 36 shows a partially cut-away side view of the structure-engaging member according to certain embodiments;

FIG. 37 a front view of the structure-engaging member according to certain embodiments;

FIG. 38 shows an exploded version of the ladder support according to certain embodiments;

FIG. 39 shows an elevational view of a first configuration of the ladder support according to certain embodiments;

FIG. 40 shows a side view of a second configuration of the ladder support according to certain embodiments;

FIG. 41 shows a side view of the first configuration of the ladder support according to certain embodiments;

FIG. 42 shows an elevational view of the ladder support in the second configuration according to certain embodiments;

FIG. 43 shows an elevational view of a ladder support in the first configuration according to certain embodiments;

FIG. 44 shows an elevational view of a ladder support according to certain embodiments; and

FIG. 45 shows an elevational view of a ladder support with a supporting tri-pod according to certain embodiments.

### DETAILED DESCRIPTION OF THE INVENTION

Apparatus, methods and media (collectively referred to herein as an “apparatus”) for providing a ladder support are provided. The ladder support may be suitable for securing a ladder against displacement.

For the sake of illustration, the invention will be described as being performed by an “apparatus.” The “apparatus” may include one or more of the features of the apparatus and methods that are shown or described herein and/or any other suitable device or approach.

Illustrative embodiments of apparatus and methods in accordance with the principles of the invention will now be described with reference to the accompanying drawings, which form a part hereof. It is to be understood that other embodiments may be utilized and that structural, functional and procedural modifications may be made without departing from the scope and spirit of the present invention.

A ladder support according to certain embodiments may include an engagement member for engaging a structure. The ladder support may also include a rung attachment assembly for engaging at least one rung of a ladder. In addition, the ladder support may include a telescoping member.

The telescoping member may be formed from a first tube of a first diameter and a second tube of a second diameter. The first diameter may be greater than the second diameter. The first diameter may be smaller than the second diameter. The telescoping member may couple the engagement member to the rung attachment assembly.

In some embodiments, the engagement member may be formed at least in part from a u-shaped member. The u-shaped member may be configured to engage a horizontal member of the structure.

In certain embodiments, the telescoping member may also include a handle for carrying the support. The handle may preferably be configured to be proximate to a center of gravity of the support when the support is in a reduced length configuration.

In some embodiments, the rung attachment assembly may include a first elongated member. The first elongated member may be for placing within a hollow rung. The rung attachment may also include a second elongated member. The second elongated member may be coupled to the first elongated member and to the telescoping member.

The second elongated member may be coupled via a fixed coupling to, or proximate to, a first end of the first elongated member. The second elongated member may be coupled via a removable coupling to, or proximate to, a second end of the first elongated member.

In certain embodiments, the fixed coupling may be obtained, at least in part, via a fixed end plate at a first end of the first elongated member. Also, the removable coupling may be obtained, at least in part, via a removable end plate proximate a second end of the first elongated member.

In a first configuration, the ladder support may be adapted to engage the structure when a horizontal component of the longitudinal axis of the ladder is configured to be perpendicular to a member of the structure that the ladder support is engaging. In another configuration, the ladder support may be adapted to engage the structure when a horizontal component of the longitudinal axis of the ladder is configured to be parallel to the member of the structure that the ladder support is engaging.

Some embodiments may include a ladder. The ladder may include an engagement member for engaging a structure. The ladder may include a telescoping member. The telescoping member may include an outer member and an inner member. The outer member may be slideably engaged with the inner member. The ladder may also include at least one locking member for fixing the position of the outer member with respect to the position of the inner member. The telescoping member may, in certain embodiments, be hingedly attached to the ladder. In certain embodiments, the attachment of the telescoping member to the ladder may be obtained using an attachment mechanism other than a hinge. Such an attachment mechanism may include, for example, a rotating rung fixedly attached to the telescoping member.

In certain embodiments, the engagement member may be formed, at least in part, from a u-shaped member. The u-shaped member may engage a horizontal member of the structure.

In certain embodiments, the outer member may include a handle. The ladder may further include a rotatable rung for attaching to the outer member. In a first configuration, the outer member may be stored substantially parallel to a horizontal component longitudinal axis of the ladder. In a second configuration, the support engagement member may engage the structure.

In some configurations, the ladder may be adapted to engage the structure when a horizontal component of the longitudinal axis of the ladder is configured to be perpendicular to a member of the structure that the ladder support is engaging. In some configurations, the ladder support may be adapted to engage the structure when a horizontal component of the longitudinal axis of the ladder is configured to be parallel to the member of the structure that the ladder support is engaging.

Some embodiments may include a ladder support that includes an extendable member for setting the length of the support. Such embodiments may include at least one locking member for fixing the position of at least a portion of the extendable member with respect to the ladder and/or with respect to another portion of the extendable member. In certain embodiments, the locking member may fix the length of the extendable member. The ladder support may also include a rung-attachment member for coupling the extendable member to the ladder. The ladder support may also include an engagement member for coupling the extendable member to a structure.

In certain embodiments, the extendable member may include a handle for carrying the support. The handle may be configured to be proximate a center of gravity of the support when the support is in a reduced length configuration.

In certain embodiments, the rung attachment member may include a first elongated member for disposing within a hollow rung of the ladder and a second elongated member parallel to the first elongated member and coupled thereto via a plurality of plates, and also coupled to the extendable member. The coupling of the first elongated member may be fixed proximate a first end of the first elongated member. The coupling of the first elongated member may be removable proximate a second end of the first elongated member. The coupling of the first elongated member and the second elongated member may be obtained via a fixed end plate at a first end of the first elongated member and via a removable end plate proximate a second end of the first elongated member.

In a first configuration, the ladder support may be adapted to engage the structure when the horizontal component of the longitudinal axis of the ladder is configured to be perpendicular to a member of the structure that the ladder support is engaging, and in a second configuration, the ladder support may be adapted to engage the structure when a horizontal component of the longitudinal axis of the ladder is configured to be parallel to the member of the structure that the ladder support is engaging.

It should be noted that the various embodiments described herein are not exclusive to one another—i.e., a part of one embodiment may be used in conjunction with one or more parts of other embodiments without departing from the scope of the invention.

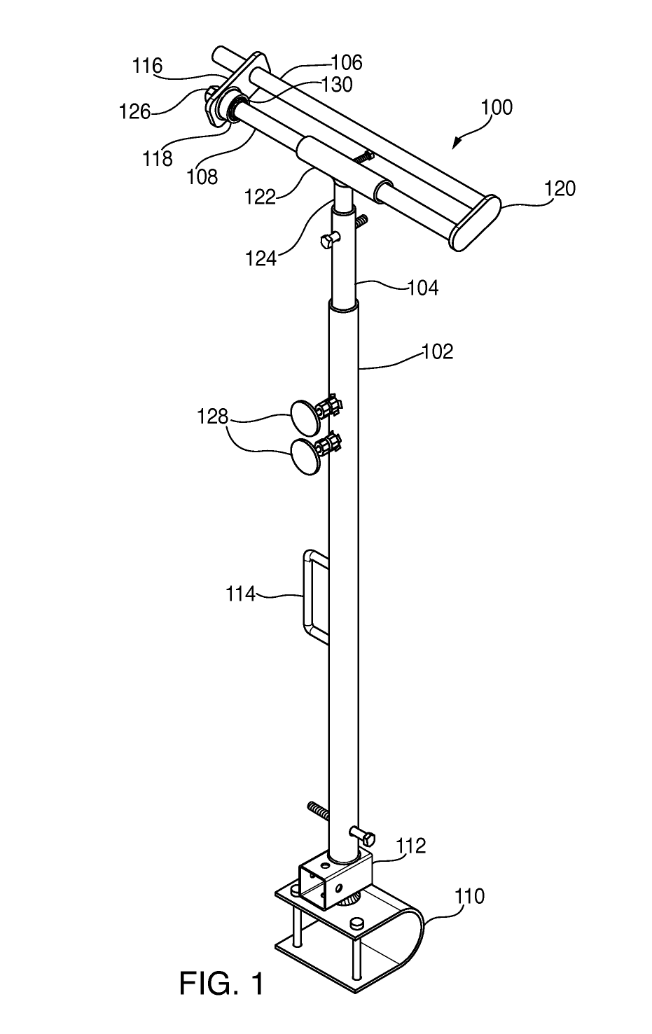

FIG. 1 shows an exemplary ladder support 100 according to certain embodiments. Ladder support 100 may include exemplary carrying member 102 and exemplary telescoping member 104. In certain embodiments, telescoping member 104 may be slideably engaged within carrying member 102.

One or more stabilization bolts 128 may be used to fix the position of carrying member 102 with respect to telescoping member 104. Other mechanisms, such as cotter pins (not shown), may be used to fix position of carrying member 102 with respect to telescoping member 104. Any suitable mechanism may be used to fix the position of carrying member 102 with respect to telescoping member 104.

In certain embodiments, carrying member 102 may include handle 114. Handle 114 may preferably be centered proximate the center of gravity of ladder support 100 when telescoping member 104 is stored within carrying member 102.

Parts 106, 108, 116, 118, 120, 122, 124, 126 and 130 all form part of a rung attachment assembly. Rung attachment assembly member 106 may preferably be fixedly coupled to rung insertion member 108 proximate one end by a preferably fixed plate 120.

Rung attachment assembly member 106 may preferably also be coupled to rung insertion member 108 by a removable plate 116. A removable attachment of plate 116 to rung insertion member 108 may preferably be obtained via bolt 126 in combination with nut 130 and preferably optional collar 118.

A t-joint formed from portions 122 and 124 may preferably be slideably attached to rung insertion member 108 and removeably attached to telescoping member 104. It should be noted that portion 122 may be fixed at preferably any suitable location on rung insertion member 108.

In the embodiment shown in FIG. 1, portion 122 is preferably fixed by a bolt proximate the center of rung insertion member 108. In certain embodiments, however, the rung attachment assembly may preferably be shifted to one side such that portion 122 may preferably be fixed at, or proximate to, one side of rung attachment assembly 108.

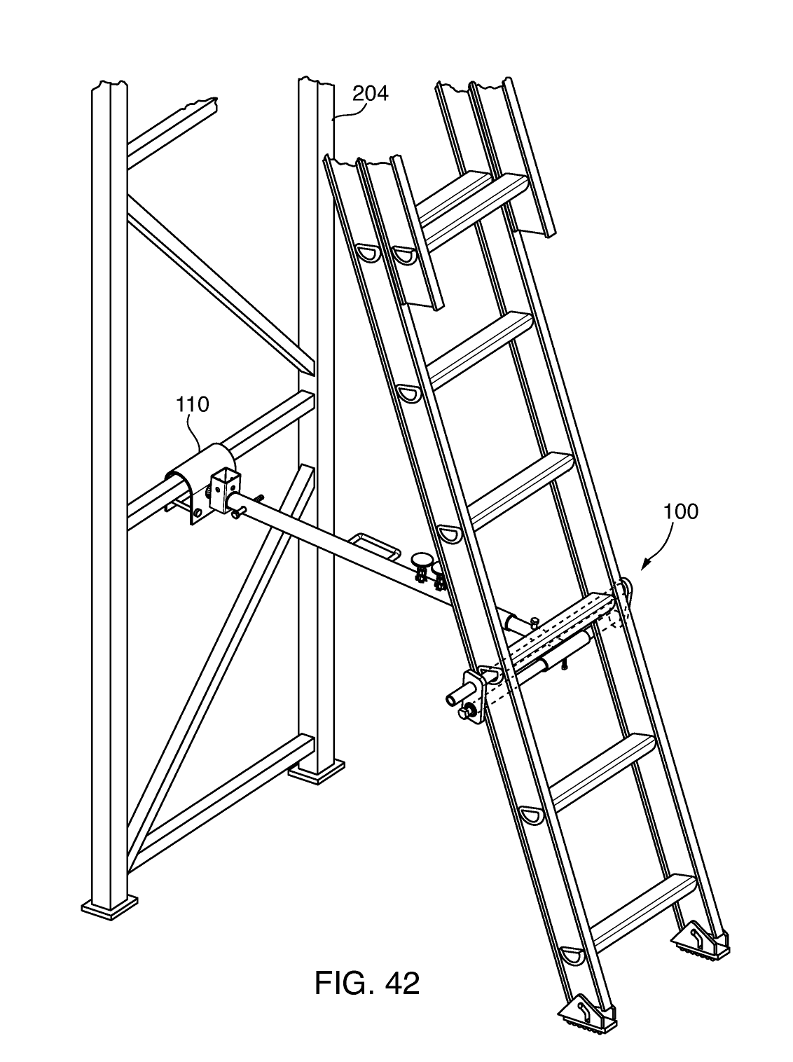

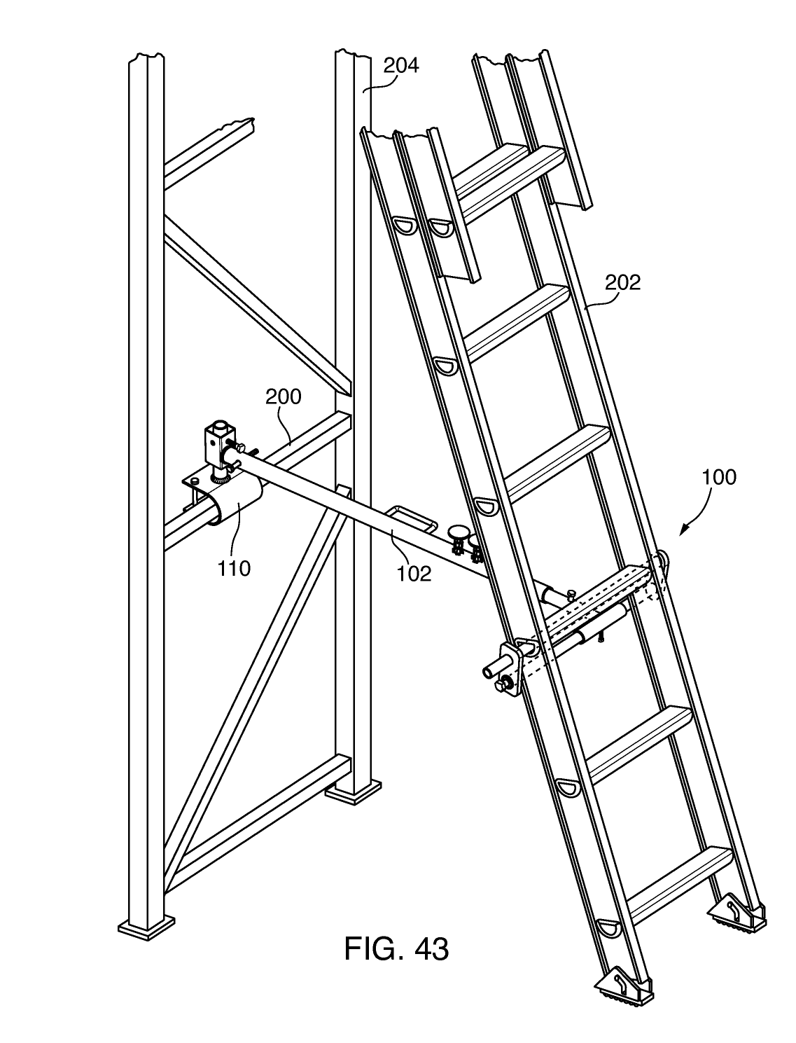

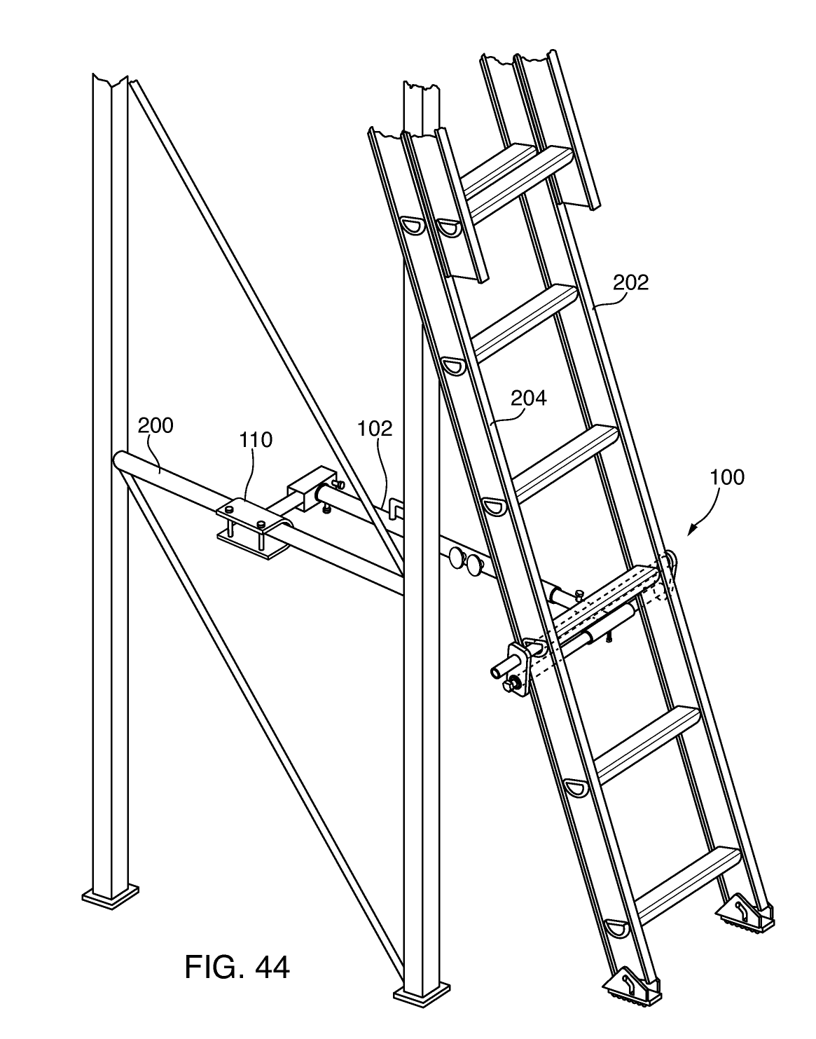

FIG. 1 also shows right-angle attachment member 112. Right-angle attachment member 112 may preferably provide at least two different attachment configurations for engagement member 110. In the first configuration shown in FIG. 1, engagement member 110 may be attached such that engagement member 110 is configured to engage a structural member, for example a scaffold, that runs perpendicular to a horizontal component of a longitudinal axis of ladder support 100. In a second configuration (shown, for example, in FIGS. 41 and 43), engagement member 110 may be attached such that engagement member is configured to engage a structural member, for example a scaffold crosspiece, that runs parallel to a horizontal component of the longitudinal axis of ladder support 100 (see, e.g., FIG. 43).

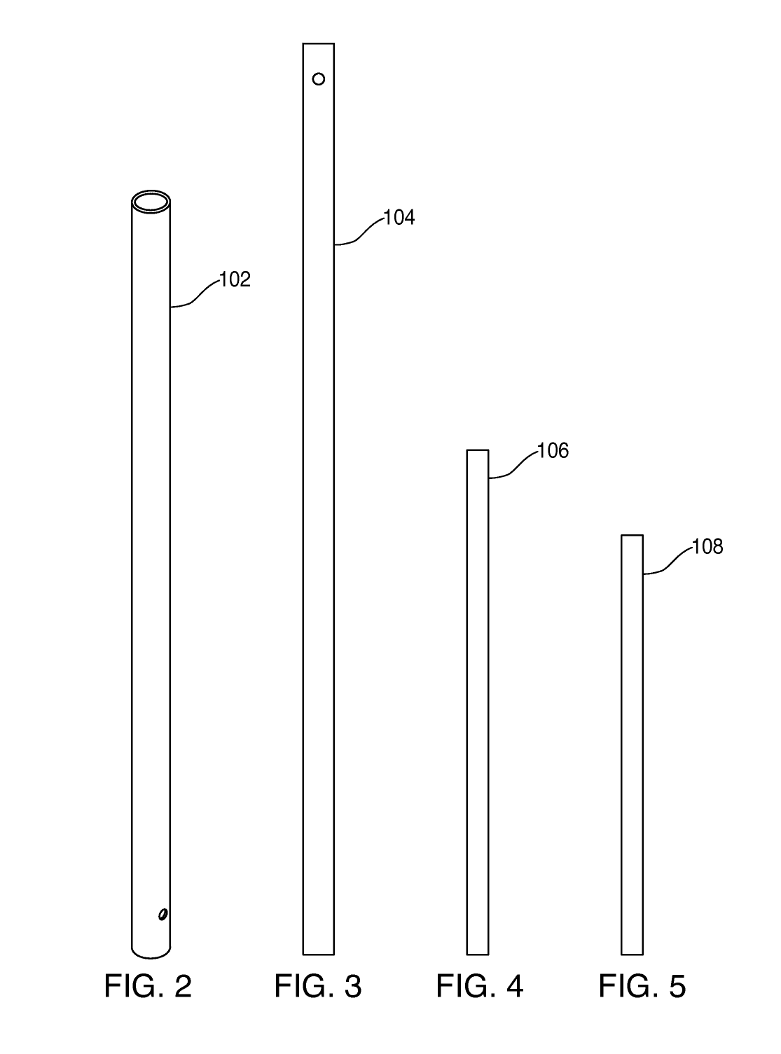

FIG. 2 shows an exemplary carrying member 102 according to certain embodiments.

FIG. 3 shows an exemplary telescoping member 104 according to certain embodiments.

It should be noted that while exemplary carrying member 102 and exemplary telescoping member 104 are shown as tubes, exemplary carrying member 102 and exemplary telescoping member 104 may also be configured in other suitable shapes. In some embodiments, exemplary carrying member 102 and exemplary telescoping member 104 may be configured as square or rectangular shapes or any other suitable shapes.

FIG. 4 shows an exemplary rung insertion member 106. FIG. 5 shows a rung attachment assembly member 108 according to certain embodiments.

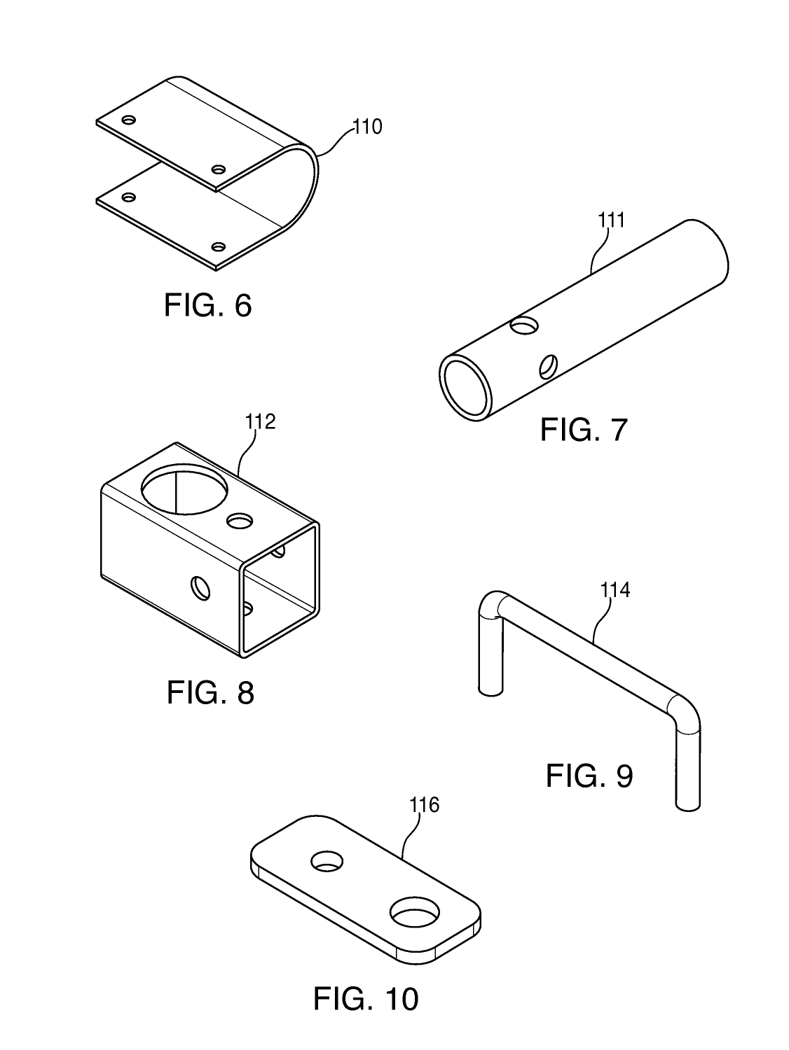

FIG. 6 shows a structure-engaging member 110 according to certain embodiments. While structure-engaging member 110 is shown in a u-shaped configuration, it should be noted that any suitable configuration may be implemented for engaging a structural member.

FIG. 7 shows structure-engaging attachment member 111 according to certain embodiments (shown in FIG. 1). Structure-engaging attachment member 111 may couple structure-engaging member 110 to right-angle engagement member 112. In certain embodiments, the coupling of structure-engaging member to right-angle engagement member 112 may enable implementation of the different configurations of the ladder support described above.

FIG. 8 shows a right-angle attachment member 112 according to certain embodiments.

FIG. 9 shows a handle 114 according to certain embodiments.

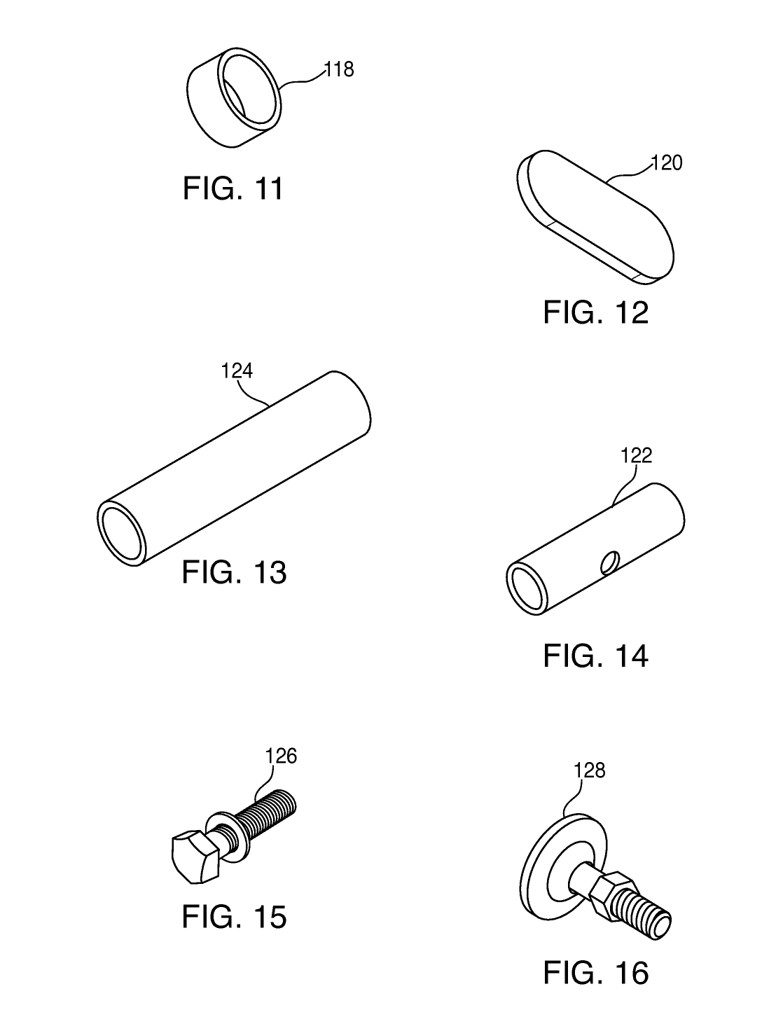

FIGS. 10-14 show various exemplary hardware associated with the rung attachment assembly according to certain embodiments. FIG. 10 shows removable rung assembly plate 116 according to certain embodiments. FIG. 11 shows collar member 118 according to certain embodiments. FIG. 12 shows a fixed plate 120 according to certain embodiments. FIG. 13 shows a first portion 124 of a rung attachment assembly t-joint according to certain embodiments. FIG. 14 shows a second portion 122 of the rung attachment assembly t-joint according to certain embodiments.

FIG. 15 shows a rung attachment assembly end bolt 126 according to certain embodiments. FIG. 16 shows an exemplary stabilization bolt 128 according to certain embodiments. It should be noted that, while stabilization bolt 128 is shown as a bolt, any suitable stabilization mechanism may be used to stabilize and/or fix the relationship between carrier member 102 and telescoping member 104 (both shown in FIG. 1).

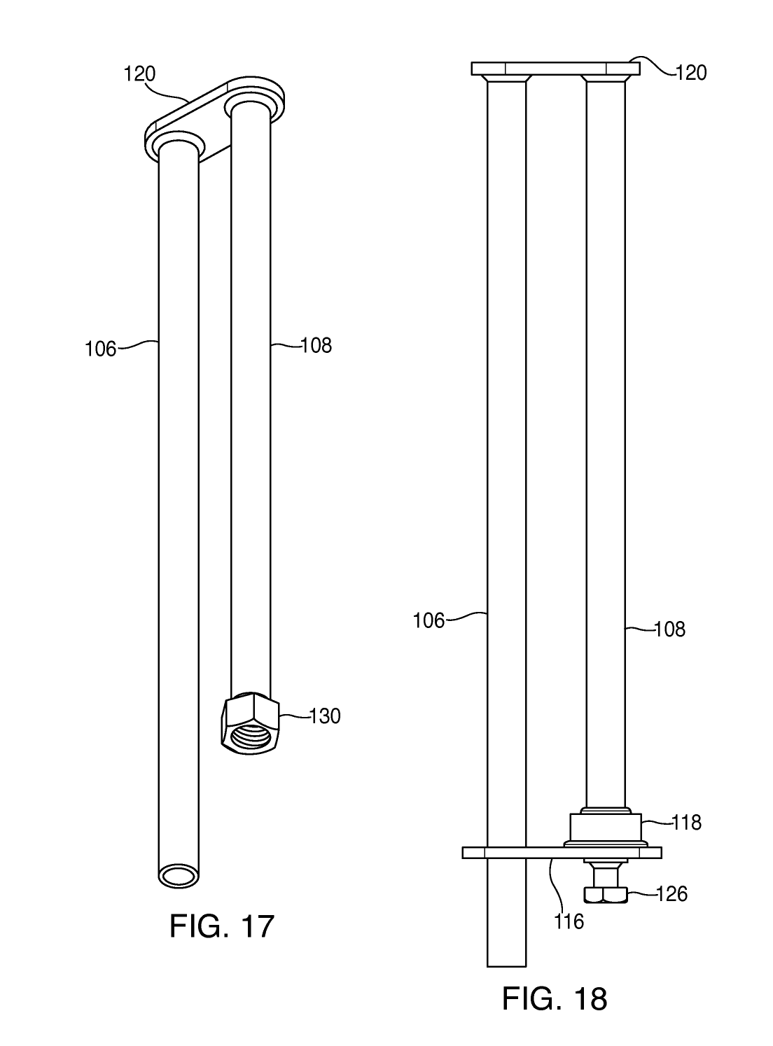

FIG. 17 shows a configuration of a portion of the rung attachment assembly according to certain embodiments. The rung attachment assembly may include rung attachment assembly member 106, rung insertion member 108, fixed plate 120 and nut 130. It should be noted that the portion of the configuration shown in FIG. 17, as configured in FIG. 17—i.e., without removable plate 116 (shown in FIG. 1)—may be appropriate for inserting the rung insertion member into a hollow rung of a ladder.

FIG. 18 shows removable plate 116 affixed, by fixed plate 120, proximate the respective ends of rung attachment assembly member 106 and rung insertion member 108, as shown in FIG. 18. Such attachment may be obtained, in certain embodiments, by end bolt 126, collar 118 and nut 130 (not shown).

It should be noted that while bolt 126, collar 118 and nut 130 are shown in FIGS. 17 and 18 as providing the attachment between removable plate 116, rung attachment assembly member 106 and rung insertion member 108, nevertheless, any suitable attaching member and/or groups of members may be used to attach rung attachment assembly member 106 and rung insertion member 108.

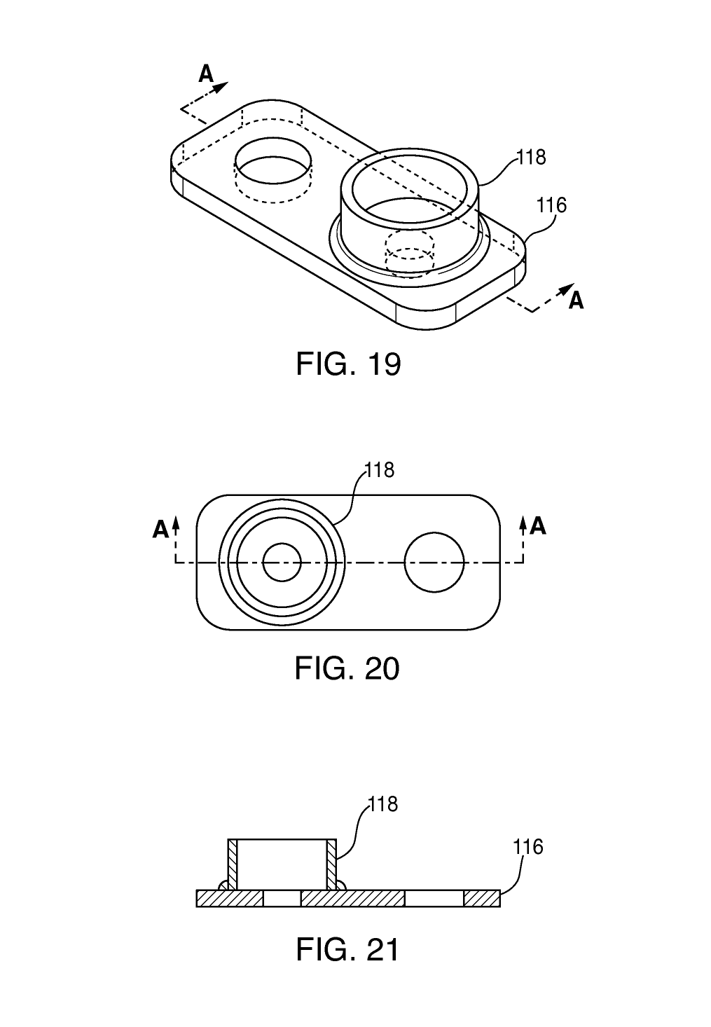

FIG. 19 shows an elevational view of removable plate 116 and collar 118 according to certain embodiments.

FIG. 20 shows a top-down view of removable rung attachment assembly plate 116 and collar taken from line A-A of FIG. 19 according to certain embodiments. It should be noted that collar 118 may either be fixedly attached to removable plate 116 or removably attached thereto. FIG. 21 is a cut-away side view of removable plate 116 and collar 118 according to certain embodiments.

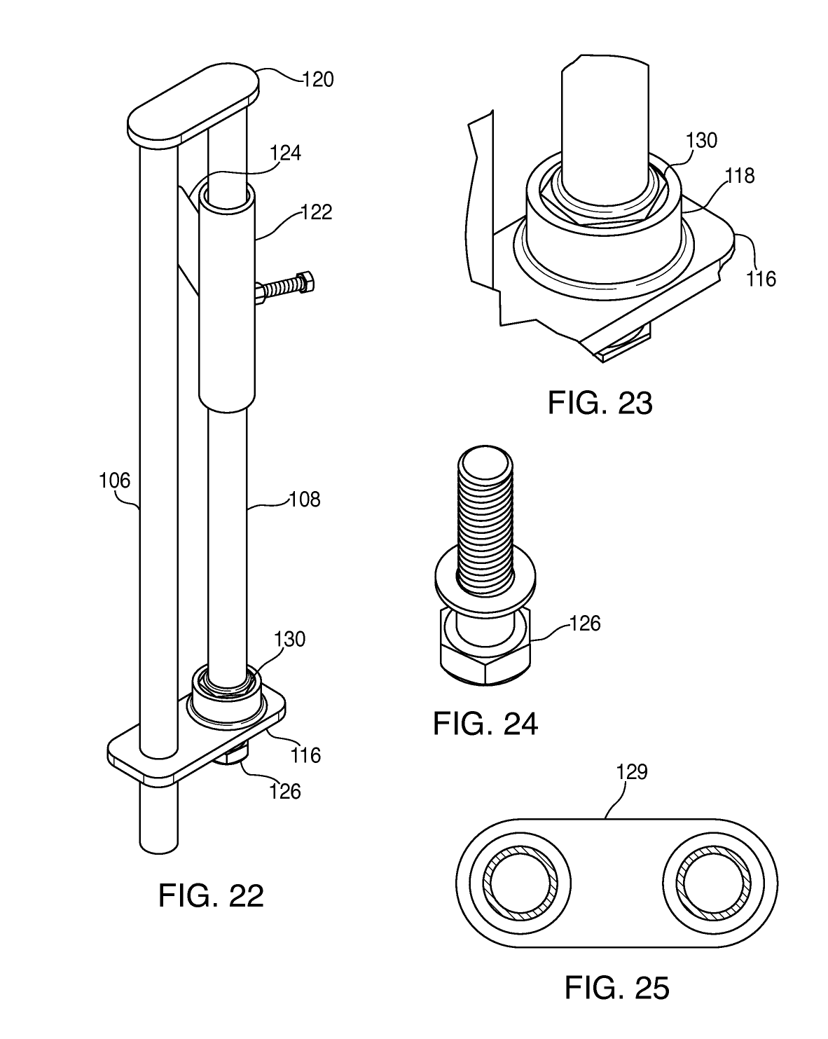

FIG. 22 shows an elevational view of a fully assembled rung attachment assembly according to certain embodiments. FIG. 22 shows rung attachment assembly member 106, rung insertion member 108, removable plate 116, fixed plate 120, portions 122 and 124 of the t-joint connection between rung insertion member 108 and telescoping member 104, end bolt 126, collar 118 and nut 130.

FIG. 23 shows an elevational view of a detail of the rung attachment assembly according to certain embodiments. Specifically, FIG. 23 shows a portion of removable plate 116, collar 118 and nut 130 in greater detail.

FIG. 24 shows an elevational view of end bolt 126 according to certain embodiments.

FIG. 25 shows an end view of the rung attachment assembly according to certain embodiments.

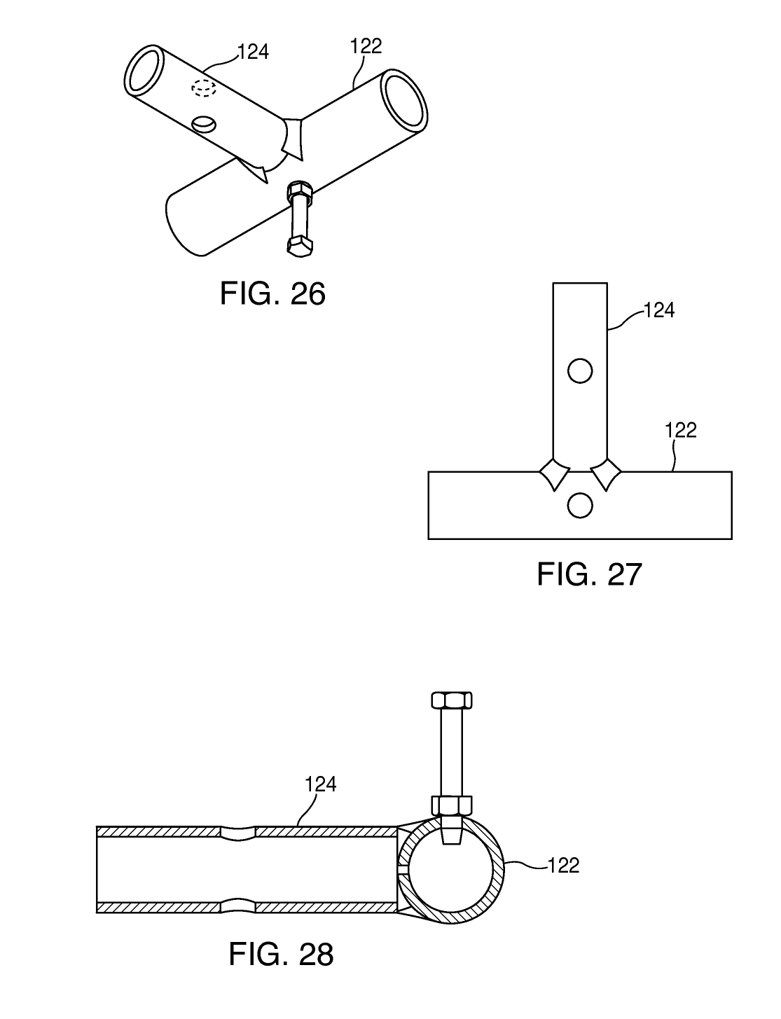

FIG. 26 shows an elevational view of the t-portion of rung attachment assembly according to certain embodiments. As noted above, the t-joint includes portions 122 and 124. FIG. 27 shows a bottom view of the t-joint of the rung attachment assembly according to certain embodiments including portions 122 and 124. FIG. 28 shows a cut-away side view of the t-portion of the rung attachment assembly including portions 122 and 124 according to certain embodiments.

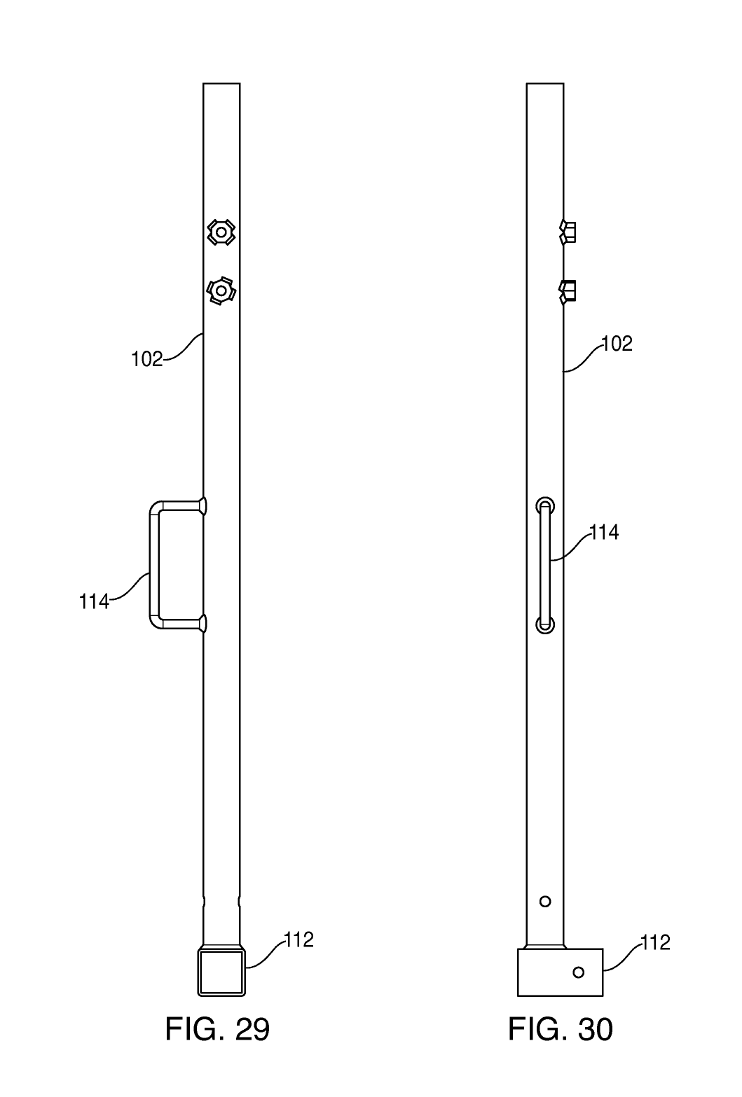

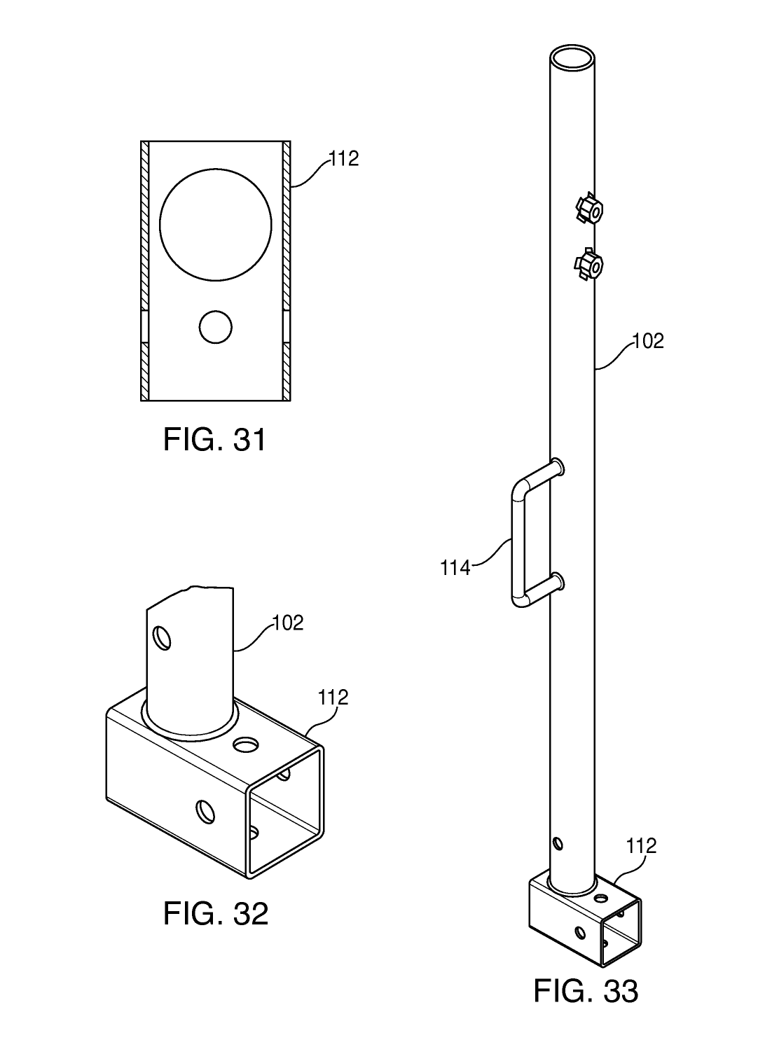

FIG. 29 shows a side view of carrying member 102 according to certain embodiments. Included in the view of carrying member 102 is handle 114 and right-angle attachment member 112. FIG. 30 shows a top view of carrying member 102 according to certain embodiments. Included in the view of carrying member 102 is handle 114 and right-angle attachment member 112. FIG. 31 shows an end view of right angle attachment member 112 according to certain embodiments.

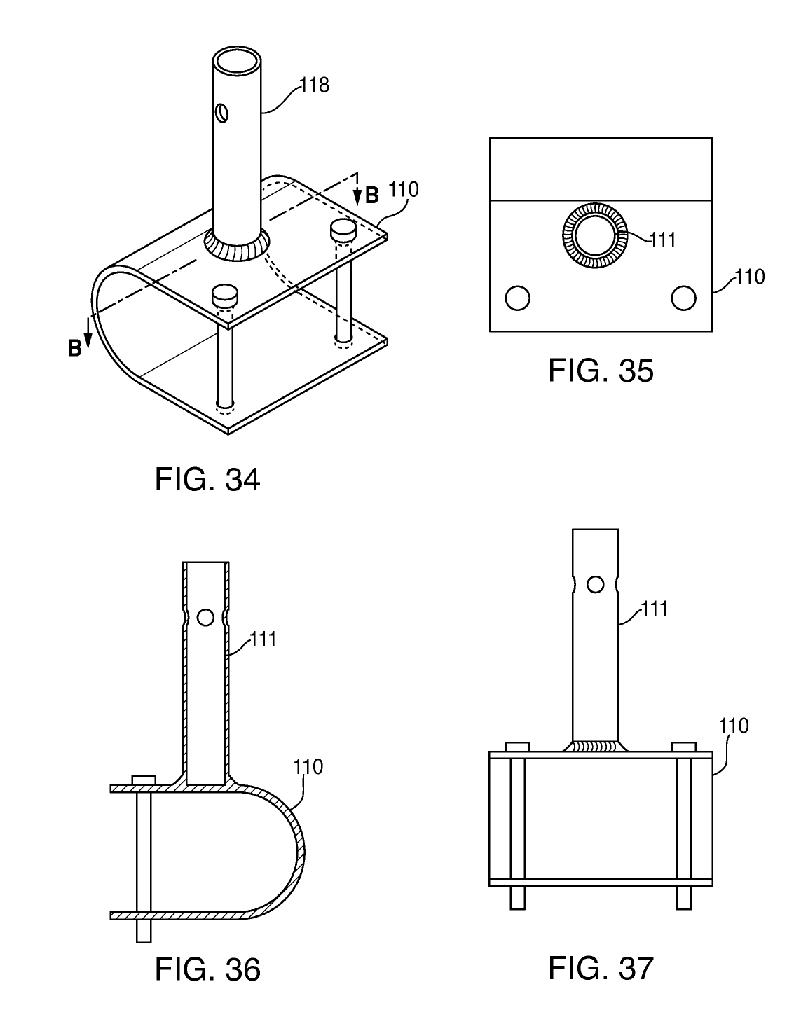

FIG. 32 shows an elevational view of right angle member 112 according to certain embodiments as well as a portion of carrying member 102. FIG. 33 shows an elevational view of carrying member 102 according to certain embodiments as well as handle 114 and right-angle attachment member 112. FIG. 34 shows an elevational view of structure-engaging member 110 according to certain embodiments. Shown as well in FIG. 34 is structure-engaging attachment member 111.

FIG. 35 shows a top-down view of structure-engaging member 110 and structure-engaging attachment member 111. FIG. 36 shows s partially cut-away side view of structure-engaging member 110 showing structure engaging attachment member according to certain embodiments.

FIG. 37 shows a front view of structure-engaging member 110 and structure-engaging attachment member 111 according to certain embodiments.

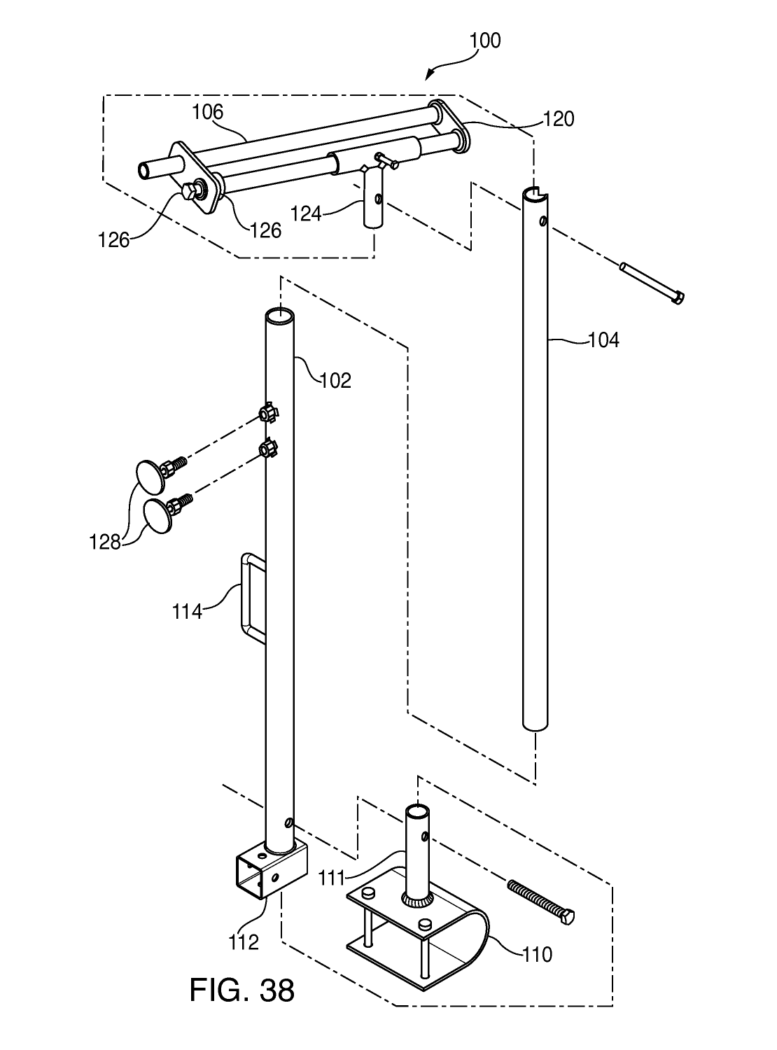

FIG. 38 shows an exploded version of ladder support 100 according to certain embodiments. FIG. 38 includes carrier member 102, telescoping member 104, rung insertion member 106, rung attachment assembly member 108, structure-engaging member 110, structure-engaging attachment member 111, right-angle attachment member 112, handle 114, removable plate 116, fixed plate 120, end bolt 126 and stabilization bolts 128.

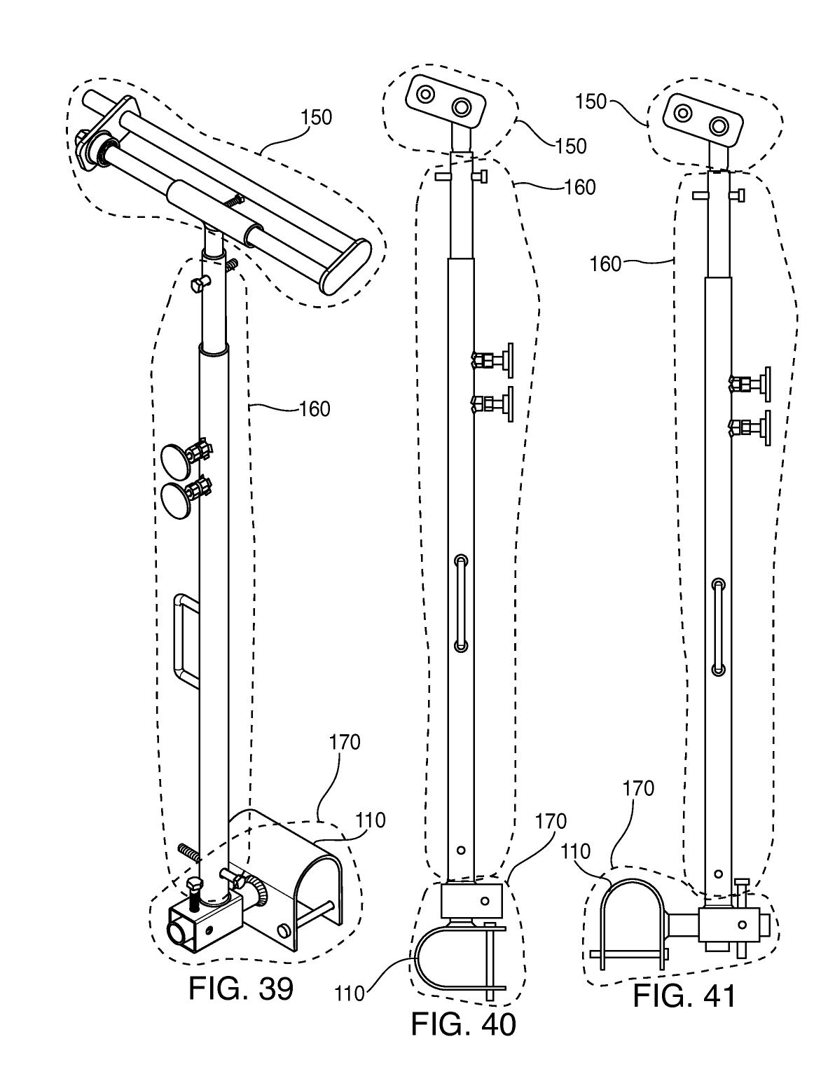

FIGS. 39 and 41 shows an elevational view of a first configuration of ladder support 100 according to certain embodiments.

FIG. 40 shows a side view of a second configuration of ladder support 100 according to certain embodiments.

FIGS. 39-41 all show ladder support 100 segregated into three groups of components—i.e., rung attachment assembly 150, expanding assembly 160 and engagement assembly 170.

FIG. 42 shows an elevational view of the ladder support 100 in the second configuration with respect to scaffolding 204 according to certain embodiments.

FIG. 43 shows an elevational view of a ladder support 100 in the first configuration with respect to scaffolding 204 according to certain embodiments.

FIG. 44 shows an elevational view of a ladder support 100 in the third configuration with respect to scaffolding 204 according to certain embodiments.

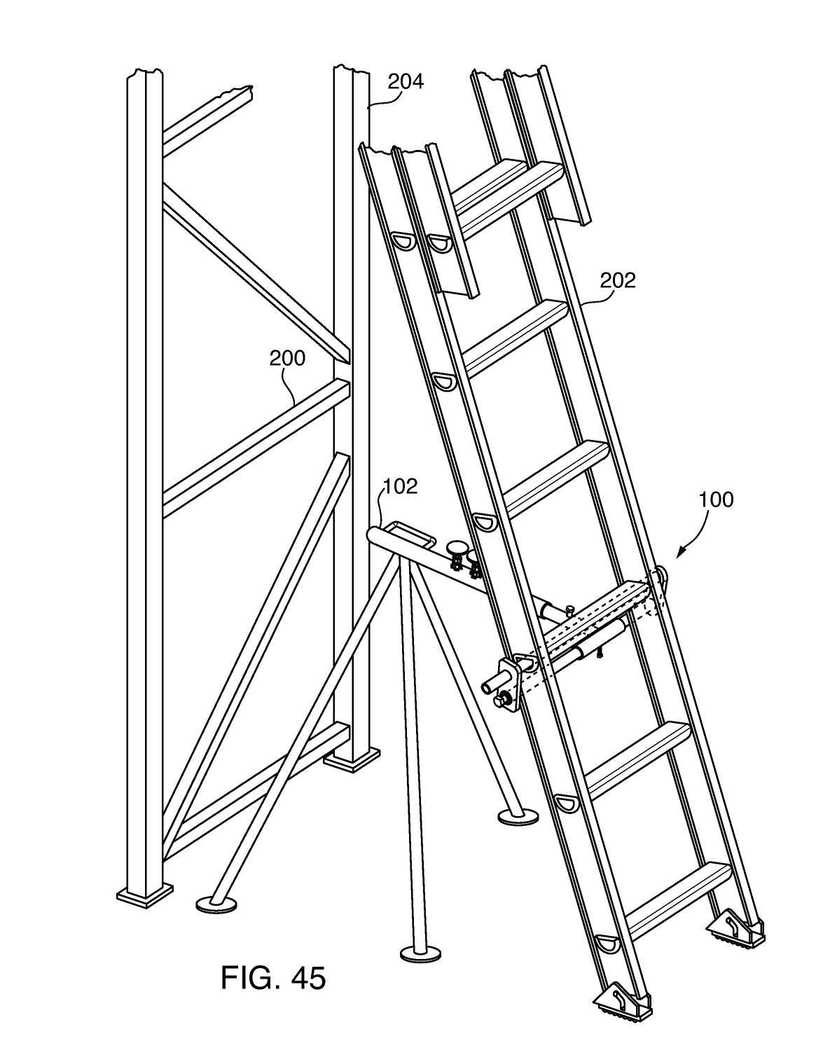

FIG. 45 shows an elevational view of a ladder support 100 including a tripod 206 with respect to scaffolding 204 according to certain embodiments. Please note that, in some embodiments, the location of the handle of the tripod may be accommodate a different center of balance associated with the tripod version(s) of the ladder support.

It should be noted that while bolts and nuts are shown as providing the attachment between various components described herein, nevertheless, any suitable attaching member such as clips, rivets, snaps, cotter pins, etc., and/or groups of members may be used to attach any of the components without varying from the scope of the invention.

Furthermore, while various different embodiments are taught in the present disclosure separately from one another, it should be noted that the various different embodiments are not exclusive from one another and may be combined as necessary without departing from the scope of the invention.

Thus, apparatus and methods for supporting a ladder have been provided. Persons skilled in the art will appreciate that the present invention can be practiced by other than the described embodiments, which are presented for purposes of illustration rather than of limitation. The present invention is limited only by the claims that follow.

What is claimed is:

1. A ladder support comprising:
an engagement member for engaging a structure;
a rung attachment assembly for engaging at least one rung of a ladder; and
a telescoping member comprising a first tube of a first diameter and a second tube of a second diameter, wherein the first diameter is greater than the second diameter, and wherein the telescoping member couples the engagement member to the rung attachment assembly.

2. The ladder support of claim 1 wherein the engagement member is at least in part u-shaped for engaging a horizontal member of the structure.

3. The ladder support of claim 1 wherein the first tube further comprises a handle for carrying the support, said handle being configured to be proximate to a center of gravity of the support when the support is in a reduced length configuration.

4. The ladder support of claim 1 wherein the rung attachment assembly comprises a first elongated member that is configured to be within a hollow rung and a second elongated member that is configured to be coupled to the first elongated member and to the telescoping member.

5. The ladder support of claim 4 wherein the rung attachment assembly comprises a fixed coupling proximate a first end of the first elongated member and a removable coupling proximate a second end of the first elongated member.

6. The ladder support of claim 5, wherein said fixed coupling is obtained, at least in part, via a fixed end plate at a first end of the first elongated member and the removable coupling is obtained, at least in part, via a removable end plate proximate to a second end of the first elongated member.

7. The ladder support of claim 1 wherein, in a first configuration, the ladder support is configured to engage the structure when a horizontal component of the longitudinal axis of the ladder is configured to be perpendicular to a member of the structure that the ladder support is engaging, and in a second configuration, the ladder support is configured to engage the structure when the horizontal component of the longitudinal axis of the ladder is parallel to the member of the structure that the ladder support is engaging.

8. A ladder comprising:
an engagement member for engaging a structure;
a telescoping member comprising an outer member and an inner member, wherein the outer member is slideably engaged to the inner member;
at least one locking member for fixing the position of the outer member with respect to the position of the inner member; and
wherein the telescoping member is hinged to the ladder.

9. The ladder of claim 8 wherein the outer member comprises, at least in part, a u-shaped member for engaging a horizontal member of the structure.

10. The ladder of claim 8 wherein the outer member further comprises a handle.

11. The ladder of claim 8 wherein the ladder further comprises a rotatable rung for attaching to the outer member, wherein, in a first configuration, the outer member is stored substantially parallel to a horizontal component of a longitudinal axis of the ladder and in a second configuration, a support engagement member engages the structure.

12. The ladder of claim 8 wherein, in a first configuration, the ladder is adapted to engage the structure when a horizontal component of the longitudinal axis of the ladder is disposed perpendicularly to a member of the structure that the ladder support is engaging, and in a second configuration, the ladder support is configured to engage the structure when a horizontal component of the longitudinal axis of the ladder is disposed parallel to the member of the structure that the ladder support is engaging.

13. A ladder support for providing support to a ladder against displacement, the ladder support comprising:
an extendable member that sets the length of the support;
at least one locking member for fixing the position of at least a portion of the extendable member with respect to a second portion of the extendable member;
a rung-attachment member for coupling the extendable member to the ladder; and
an engagement member for coupling the extendable member to a structure.

14. The ladder support of claim 13 wherein the engagement member is at least in part u-shaped for engaging a member of the structure.

15. The ladder support of claim 13 wherein the extendable member further comprises a handle for carrying the support.

16. The ladder support of claim 15 wherein said handle is disposed proximate to a center of gravity of the support when the support is in a reduced length configuration.

17. The ladder support of claim 13 wherein the rung attachment member comprises a first elongated member for disposing within a hollow rung of the ladder and a second elongated member parallel to the first elongated member and coupled thereto via a plurality of plates, and also coupled to the extendable member.

18. The ladder support of claim 17, wherein said second elongated member is coupled via a fixed coupling proximate a first end of the first elongated member and coupled via a removable coupling proximate a second end of the first elongated member.

19. The ladder support of claim 18, wherein said fixed coupling is obtained via a fixed end plate and said removable coupling is obtained via a removable end plate.

20. The ladder support of claim 13 wherein, in a first configuration, the ladder support is adapted to engage the structure when a horizontal component of the longitudinal axis of the ladder is disposed perpendicularly to a member of the structure that the ladder support is engaging, and in a second configuration, the ladder support is adapted to engage the structure when the horizontal component of the longitudinal axis of the ladder is disposed parallel to the member of the structure that the ladder support is engaging.

21. A ladder comprising:
a support engagement member for engaging a structure;
a telescoping member comprising an outer member and an inner member, wherein the outer member is slideably engaged with the inner member;
at least one locking member for fixing a position of the outer member with respect to a position of the inner member;
wherein the telescoping member is hingedly attached to the ladder via a rotatable rung for attaching to the outer member;
wherein, in a first configuration, the outer member is stored substantially parallel to a horizontal component longitudinal axis of the ladder and in a second configuration, the support engagement member engages the structure.
